(19) United States
(12) Patent Application Publication
(10) Pub. No.: US 2020/0315213 A1
(43) Pub. Date: Oct. 8, 2020

(54) PET FOOD PRODUCT AND METHOD FOR MAKING

(71) Applicant: William M. Sherk, JR., Oakwood, OH (US)

(72) Inventor: William M. Sherk, JR., Oakwood, OH (US)

(73) Assignee: MiracleCorp Products, Dayton, OH (US)

(21) Appl. No.: 16/839,866

(22) Filed: Apr. 3, 2020

Related U.S. Application Data
(60) Provisional application No. 62/829,299, filed on Apr. 4, 2019.

(51) Int. Cl. A23K 10/30; A23K 20/174; A23K 20/142; A23K 20/158; A23K 50/42; A23K 50/48; B65D 81/18; A23K 20/189

(52) U.S. Cl. CPC A23K 10/30; A23K 20/174; A23K 20/142; A23K 20/189; A23K 50/42; A23K 50/48; B65D 81/18; A23K 20/158

(57) ABSTRACT

A pet food product including a storage container and a first pet food product in the form of solid components having a first average particle size, wherein the first pet food product is positioned in the storage container. The pet food product further includes a second pet food product in the form of at least one of a liquid, a gel, a paste, a powder, or solid components having a second average particle size that is smaller than the first average particle size. The second pet food product is positioned in the storage container and generally separated from the first pet food product. The first pet food product alone does not provide a fully compliant pet food product, the second pet food product does not alone provide a fully compliant pet food product, and the first and second pet food products have a composition such that when a sufficient amount of the first pet food product and a sufficient amount of the second pet food product are combined, a compliant pet food product results.

This Application claims priority to U.S. Provisional Patent Application Ser. No. 62/829,299 filed on Apr. 4, 2019, the entire contents of which are hereby incorporated by reference.

The present disclosure is directed to a pet food product, and more particularly, to a pet food product with ingredients that can be combined by the user.

### BACKGROUND

Pet food is typically made of various discrete components, such as pellets or the like, that are blended together. The pellets or the like may be combined with powders, fine grains, liquids, etc. in order to provide a complete and balanced pet food. However during shipment and storage the pet food product may experience settling such that the smaller sized pellets or powder migrate to the bottom of the storage container. The issue may be particularly prevalent in customized pet food products where the type and size of ingredients may vary from batch to batch.

### SUMMARY

The present disclosure is directed to a pet food product and a method of making a pet food product where different ingredients can be utilized, but kept separate to be combined by the user. More particularly, in one embodiment the invention is a pet food product including a storage container and a first pet food product in the form of solid components having a first average particle size, wherein the first pet food product is positioned in the storage container. The pet food product further includes a second pet food product in the form of at least one of a liquid, a gel, a paste, a powder, or solid components having a second average particle size that is smaller than the first average particle size. The second pet food product is positioned in the storage container and generally separated from the first pet food product. The first pet food product alone does not provide a fully compliant pet food product, the second pet food product does not alone provide a fully compliant pet food product, and the first and second pet food products have a composition such that when a sufficient amount of the first pet food product and a sufficient amount of the second pet food product are combined, a compliant pet food product results.

### BRIEF DESCRIPTION OF THE DRAWINGS

FIG. 1 is a front perspective view of a packaged pet food system;

FIG. 2 is a front perspective view of the system of FIG. 1, with portions of the containers cut away for illustrative purposes;

FIG. 3 is a front perspective view of another packaged pet food system, with portions of the containers cut away for illustrative purposes;

FIG. 4 is a side view of a pet bowl with a meal provided from the system of FIG. 2;

FIG. 5 is a front view of a mobile device illustrating an exemplary process for ordering a pet food;

FIG. 6 is a front view of the mobile device of FIG. 5 illustrating a next step in an exemplary process for ordering a pet food;

FIG. 7 is a schematic illustration of a filling system for filling the larger inner container of the system of FIGS. 1-3; and

FIG. 8 is a schematic illustration of a filling system for filling the smaller inner container of the system of FIGS. 1 and 2.

### DETAILED DESCRIPTION

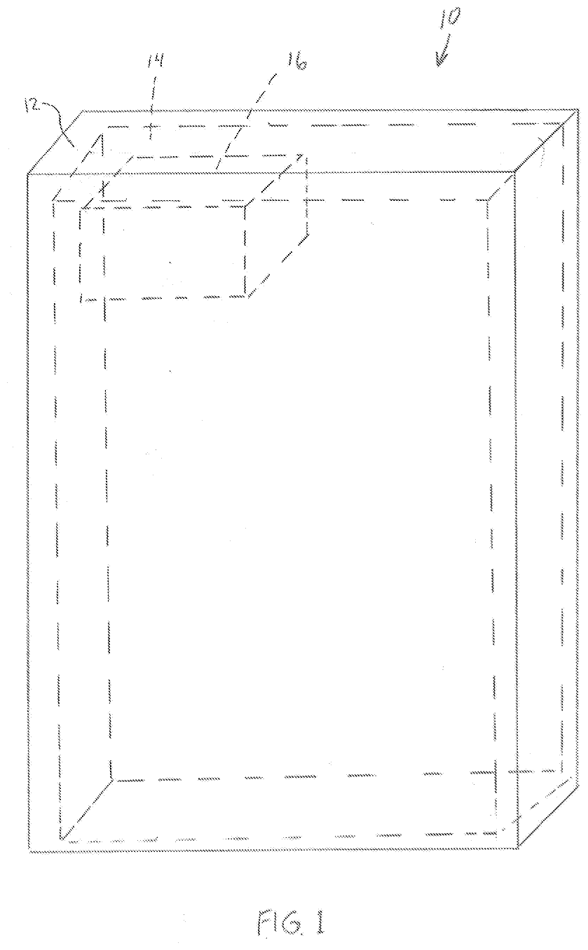

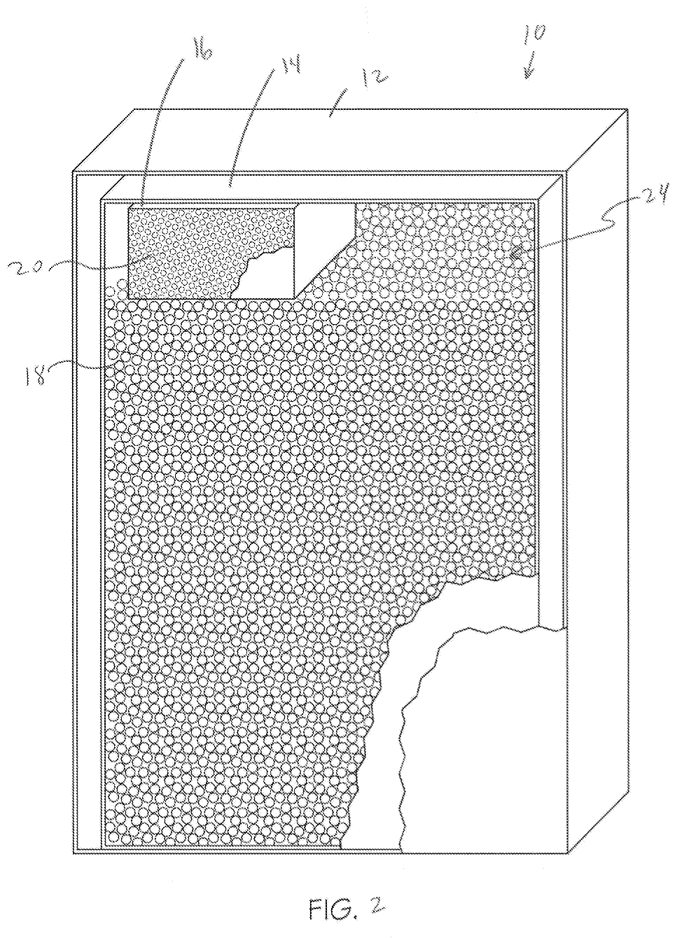

FIGS. 1 and 2 illustrate one embodiment of a pet food system 10 including a first or outer-most storage container, bag, box or storage device 12 (collectively termed a “storage container” herein), a second or intermediate storage container 14 positioned within the first storage container, and a third or inner-most storage container 16 positioned within the second storage container 14. Each of the storage containers 12, 14, 16 can have any of a wide variety of shapes and configurations, and can be made of paper, cardboard, polymers, or the like. Each container 12, 14, 16 is shown in a generally “box-like” rectangular prism configuration, but in some cases, particularly for the second 14 and/or third containers 16, they can be generally flexible and manually deformable to the desired shape. Each container 12, 14, 16 may be generally sealed or closed and include a slit, seal or access point (not shown) which can be manually open or torn to allow a user to access the content of each container 12, 14, 16.

In the embodiment of FIGS. 1 and 2, the first container 12 closely receives the second container 14 therein, the second container 14 stores a first pet food product or ingredients 18 therein, and the third storage container 16 stores a second pet food product or ingredient 20 therein. In one embodiment, the first pet food product 18 takes the form of or includes solid components such as pellets, particles or kibble (collectively termed “pellets” herein). The pellets of the first pet food product 18 are shown in FIG. 2 as being generally spherical, but can be any of a wide variety of other shapes including for example extruded shapes (e.g. shapes with a constant cross-sectional shapes such as cylinders or the like), cubes, irregularly-shaped components, etc.

The first pet food product 18 can include “bulk” ingredients which are generally required to be provided in bulk amounts to provide a complete and balanced, certified pet food meal. Such bulk ingredients can include proteins, fruit, vegetables, carbohydrates, dietary fiber or grains (including ancient grains), or other ingredients such as fractionated oil. The pellets of the first food product may also include or be made of any of the other ingredients listed below as or for the contents of the second pet food product 20, or indeed any animal-edible ingredient, in one case in solid form (including dry or semi-moist form) which generally keeps its shape/form and dimensional stability when stored or stacked (in the absence of outside forces, such as sufficient crushing or compressive forces). The first pet food product 18 can in one case be dehydrated or relatively dry, and have a moisture content of less than about 15% by weight in one case, or less than about 10% by weight in another case.

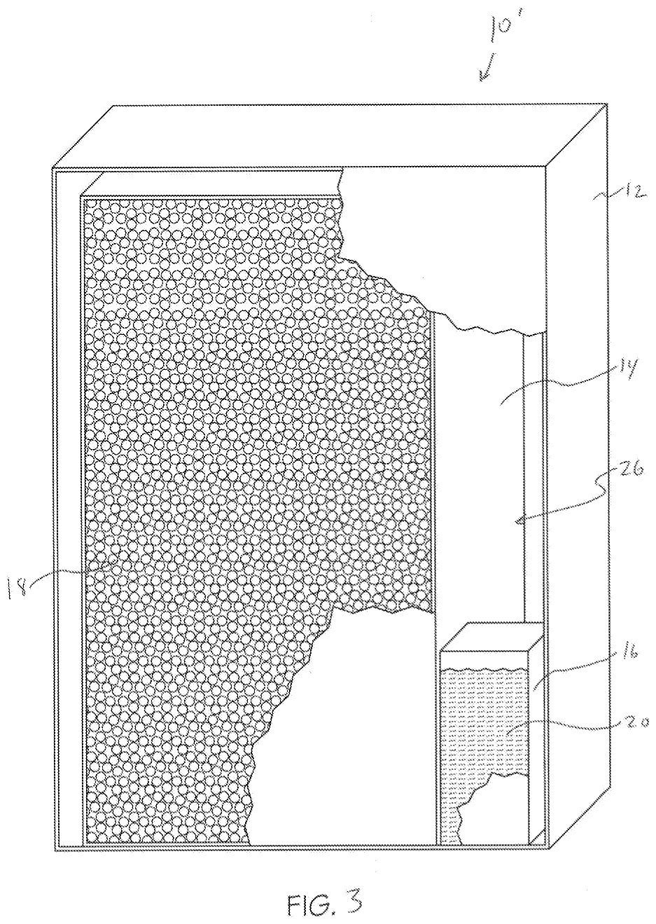

The second pet food product 20 can also include or take the form of a solid component such as pellets, but may instead or also take the form of a liquid, gel, paste or powder. Rather than the “bulk” ingredients which may be provided by the first pet food product 18, the second pet food product 20 can provide “supplemental” ingredients required to provide a complete and balanced, certified pet food meal, such as oils, amino acids, minerals, vitamins, spices, enzymes, probiotics, prebiotics, nutraceuticals, etc., and in one case may lack or be substantially free of any dietary fiber, or include less than 5% in one case, or less than 1% in another case, dietary fiber by weight and/or volume. When the second pet food product 20 includes powders, such powders can be considered to be comprised of solid components of a relatively small size, and such liquids, gels and pastes can also include small solid components dissolved or suspended in a solution. FIG. 2 illustrates the second pet food product 20 in the form of solid pellets, and FIG. 3 illustrates another embodiment of a pet food system 10′ wherein the second pet food product 20 is in the form of a liquid, gel, powder or paste, which can be either oil or water based.

Certain organizations set forth standards and provide model pet food regulations which can be adopted by government bodies, regulatory bodies and/or by pet food manufacturers. For example, these standard setting organizations include the Association of American Feed Control Officials (“AAFCO”) and the European Pet Food Industry Federation (Federation Europeenne de l′Industrie des Alimentis pour Animaux Familiers (“FEDIAF”)) which specify certain minimums, and in some cases maximums, relating to the amount of ingredients or qualities of pet food, typically on a weight percentage basis or based on calorie content, where the ingredients or qualities can include protein, fat, mineral, fibers, vitamins and others. These standards and regulations may address other qualities of the pet food product such as caloric density, protein concentration, moisture content, with an ultimate standard (at least in the case of AAFCO standards) of providing “complete and balanced” nutrition. In particular, certain specific AAFCO standards that relates to dogs and cats, including those included or incorporated in the AAFCO 2016 and/or 2019 and/or 2020 Official Publication, which standards as of the filing date of this application are entirely incorporated by reference herein. In one case, in order to have a “complete and balanced” dog or cat food, the food must either meet one of the dog or cat food Nutrient Profiles established by AAFCO or pass a feeding trial using AAFCO procedures. For a product to meet one of the AAFCO nutrient profiles, it must contain every nutrient listed in the profile, at least at the recommended level.

When the second pet food product 20 is in the form of or includes solid components, in one case those solid components can have a smaller (average) size or smaller (average) particle size than that of the solid components or pellets of the first pet food product 18. Size, particle size or average particle size of the solid components can be determined by any of a variety of methods. When the components or particles/pellets are spherical, a diameter of the sphere can determine size or particle size. When the components or particles/pellets are not spherical, a given component can be replaced with an imaginary sphere that has a volume equal to the component under consideration, and the diameter of that sphere then determines an effective diameter; volume can be determined by various means, such as liquid displacement or others. Size or average particle size can also be determined by photoanalysis, or optical granulometry, or sieve analysis in one case using standards known to a person of ordinary skill in the art, and in particular in one case using relevant ASTM or ISO standards, such as ASTM D6913 standards and/or ASTM D1921 standards and/or ASTM C 136 standards and/or ISO 9276 standards, each standard of which is, as of the filing date of this Application, incorporated herein in its entirety.

The pellets of the first pet food product 18 can in one case have an average effective diameter (e.g. equivalent spherical diameter) of at least about 0.1 inch, or at least about 0.25 inches, or less than about 1 inch, or between about 0.25 inches and about 1 inch. Each pellet of the first pet food product 18 can in one case have a volume or equivalent volume of less than about 4 cubic inches and/or greater than about 0.004 cubic inches. In contrast, the solid components (if any) of the second pet food product 20 can in one case have an average effective diameter of less than about 0.1 inch in one case, or less than about 0.25 inches. In one case the solid components of the first pet food product 18 can have an effective average diameter that is at least about 50 percent greater in one case, and at least about 100 percent greater in another case, and at least about 200 percent greater in yet another case, than the effective average diameter of the solid components (if any) of the second pet food product 20.

The pellets of the first 18 and second 20 pet food products can each have a size, volume and/or weight that is generally similar to the other pellets of the associated food product 18, 20. In one case, the pellets have an average effective diameter and/or weight and/or volume that is within about 25 percent in one case, and 50 percent in another case, of an average effective diameter and/or weight and/or volume, respectively, of other ones of the pellets of the associated food product 18, 20. Since the first pet food product 18 provides bulk ingredients and may be larger in particle size than the second pet food product 20, the first pet food product 18 can take up a volume in the containers 12 or 14 that is greater than the volume of the second pet food product 20 in the containers 12 or 16. In one case, the first pet food product 18 in the second container 14 has a volume of at least four times greater, and in another case at least ten times greater, than the volume of the second pet food product 20 in the containers 12 or 16.

As outlined above, the first pet food product 18 can in one case be considered to include more relatively “bulk” ingredients, such as proteins, fruit, vegetables, carbohydrates, grains, and dietary fiber while the second pet food product 20 can in one case be considered to include more “supplement” ingredients such as oils, amino acids, minerals, vitamins, spices and enzymes. Accordingly, in one embodiment, the first pet food product 18 alone does not or cannot provide a fully compliant pet food product (e.g. compliant with all or some of the relevant standards and regulations identified above) since it can in one case lack certain “supplements” that may be required and included in the second pet food product 20. Conversely, the second pet food product 20 may not alone provide a fully compliant pet food product since it can lack the “bulk” ingredients provided by the first pet food product 18.

In alternative embodiments, however the first 18 pet food product can include the required supplements and/or second 20 pet food product can include the required bulk ingredients. Thus in this alternative the first 18 and/or second 20 pet food products alone can each provide a fully compliant pet food product (e.g. provide complete and balanced nutrition). In a further alternative embodiment, the second pet food product 20 can be positioned in two (or more) separate third containers 16 (not shown). For example, the second pet food product 20 can include some oil-based ingredients and some water-based ingredient that may not properly mix, and thus are packaged separately. Alternatively, the second pet food product 20 can include some liquid ingredients and some solid ingredients, and thus be packaged separately. In this case one or both or all of the third containers 16 storing the second pet food product 20 can be considered to be the third container 16. Moreover, if desired, the first pet food product 18 can be spread across multiple second containers 14 in the same or similar manner.

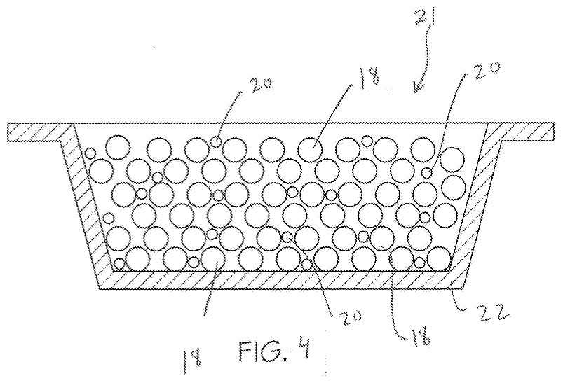

When the first 18 and/or second 20 pet food products alone do not or cannot provide a fully compliant pet food product (e.g. each alone is compliant with only some of the relevant standards and regulations), or in other cases to simply provide improved texture, appearance, flavor, scent or nutritional value, the first 18 and second 20 food products may be designed and configured for use together. For example, a user may be instructed or required to combine a certain amount of the first pet food product 18 and second pet food product 20 in the instructed amounts. In one case, printed instructions can be included on or in any one of the containers 12, 14, 16, or otherwise provided to the user such as in electronic or print form. The instructions can direct a user to fill a container, such as a pet food bowl 22 shown in FIG. 4, with a specified amount (for example, in one particular case, one cup) of the first pet food product 18 using a scoop provided in the container 12 in one case for example. The instructions may next direct the user to add a specified amount (for example, in one particular case one tablespoon) of the second pet food product 20 to the bowl 22 (using another provided scoop for example). The second pet food product 20 can be sprinkled, sprayed, dispensed with a dispenser that meters a precise quantity of the second pet food product 20, etc. If desired, the ingredients 18, 20 may be mixed to provide a relatively even distribution prior to consumption. Once the ingredients 18, 20 are provided in the bowl 22 in sufficient quantities as directed, a complete and balanced and compliant pet food product or meal 21 can result.

In one case, due to the relatively bulky nature of the first pet food product 18, the amount of the first pet food product 18 in the bowl 22 (e.g. in one case the minimum amount of the first pet food product 18 required to provide a fully compliant pet food product) is at least four times greater by volume and/or weight in one case, and at least about ten times greater by volume and/or weight in another case, than the amount of the second pet food product 20 in the bowl 22 (e.g. in one case the minimum amount of the second pet food product 20 required to provide a fully compliant pet food product).

Due to the smaller grain size and/or liquid/gel/paste nature of the second pet food product 20, the second pet food product 20 can flow down through gaps/openings in the first pet food product 18 and provide a relatively even distribution thereof, as shown in FIG. 4. The system described herein in which the first 18 and second pet food products 20 remain isolated prior to mixing helps to eliminate settling issues by insuring commonly-sized ingredients are grouped together, and differently-sized ingredients are kept separated, and are mixed immediately prior to consumption. Avoiding settling of ingredients helps to ensure that the pet consumes the ingredients in the desired proportions to ensure proper nutrition and desired taste profile. In addition, the system 10 avoids issues in having to blend the differently-sized ingredients before shipping.

Separating the first 18 and second 20 pet food products also enables different types of packaging to be used; for example, the third container 16 can be an airtight and non-light penetrating packaging such as a foil pouch, while the second container 14 can be made of more inexpensive, and less air-tight and/or light blocking material such as paper or cardboard. In this manner ingredients which require special packaging to retain freshness or flavor (e.g. the second pet food product 20 in one case) can be so packaged, while other ingredients (e.g. the first pet food product 18 in one case) may not utilize such packaging, providing a cost savings.

The first pet food product 18 and the second pet food product 20 can thus be separated from each other to provide these benefits. In one case, as outlined above, the first pet food product 18 is entirely contained within the second container 14, and no portions of the second pet food product 20 are positioned (directly) in the second container 14 (except trace amounts (e.g. less than about 5% in one case, and less than about 1% in another case by volume and/or weight) and/or any amounts received in the third container 16). Conversely, in one embodiment the second pet food product 20 is entirely contained within the third container 16, and no portions of the first pet food product 18 are positioned in the third container 16 (except trace amounts).

In one case, the first 18 and second 20 pet food products are substantially unblended when in their respective containers 14, 16 such that each container 14, 16 includes at least about 95 percent of the associated pet food products 18, 20 of the container 12 by weight and/or volume. Thus, in one case, the first 18 and second 20 pet food products are positioned in separate containers 14, 16 and isolated (or fluidly isolated) from each other. In alternate embodiments, however, the first 18 and second 20 pet food products can be positioned within a single container, and separated by partitions, dividers or the like. In one case the first 18 and second 20 pet food products can be completed isolated (or fluidly isolated) during shipping but common and direct access to both the first 18 and second 20 pet food products may be provided after opening an associated one of the containers 14, 16 (e.g. after a user or customer tears open a seam along the top of the container 14).

The first container 12 can be used as an outer shipping box or protective component but which can provide protection during shipping. However, in some cases, if desired, the first container 12 may be omitted from the system 10, and the second container 14 (with, in one case, the third container 16 positioned therein) can be shipped and/or stored directly.

FIG. 2 illustrates the second container 14 nearly filled with the first pet food product 18, with the third container 16 positioned in an open headspace volume 24 above, and resting on/supported by the first pet food product 18. In this case, spacers, fillers or other items (not shown) can be positioned adjacent to the third container 16 to fill the remaining headspace volume 24 in the second container 14 to prevent shifting. FIG. 3 illustrates an alternate embodiment in which the second container 14 is generally fully filled with the first pet food product 18 and the third container 16 is positioned outside of, and laterally adjacent, to the second container 14, and in this case the associated second pet food product 20 happens to contain a fluid, gel, powder or paste. Again, spacers, fillers or other materials can be positioned within the lateral space 26 adjacent to the second container 14 and above the third container 16 to prevent shifting of the third container 16. In one case, the first 12, second 14 and third 16 containers together have a weight of between about 10 pounds and about 35 pounds to provide a useful volume of pet food material, while being sufficiently light to be manually carryable.

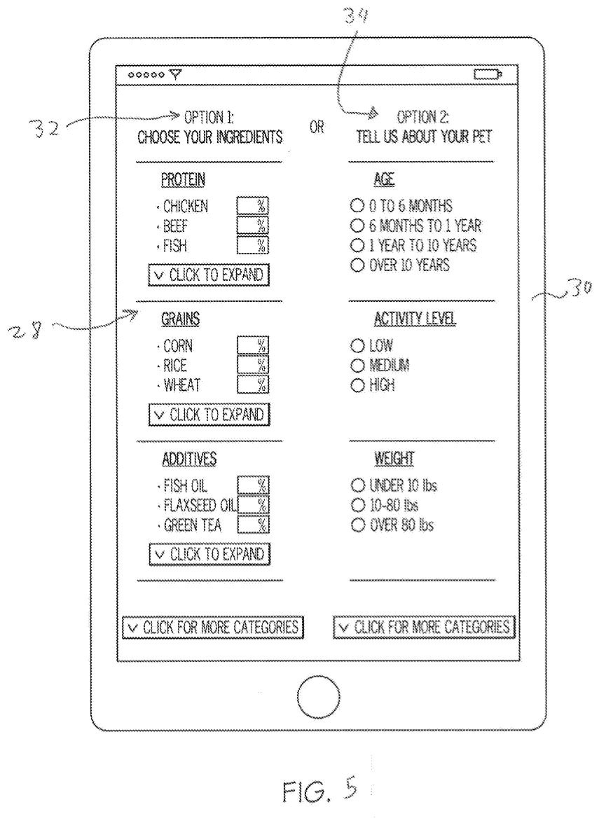

The pet food systems 10, 10′ of FIGS. 1-3 can be useful with (but are not necessarily required to be used with) a customizable pet food system. For example, with reference to FIG. 5 a user may access and use an interactive website, mobile device app, etc. 28, in conjunction with a computer, tablet, mobile phone or mobile device 30 to order or request a custom blend of pet food. The information input by the user can then be provided to a supplier of pet food products, or a business partner or the like, who can receive such information from the user via the internet.

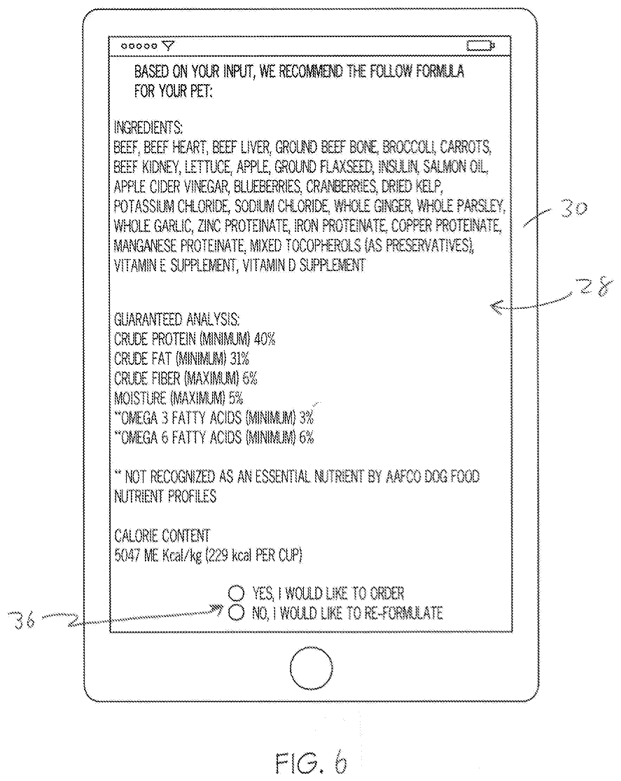

In the particular illustrated case of FIG. 5, the app 28 presents to the user first 32 and second 34 options for entering information. Under the first option 32 the user is cued to specify the desired amounts of ingredients in a pet food product under various predefined categories such as proteins, grains, additives, etc. Under the second option 34, a user is cued to enter information in a questionnaire format, such that the user can input information such as the pet's breed, age, activity level, weight, etc. After receiving the user's input, the app 28/system can formulate a specific mix of ingredients based on the user's input and present the proposed blend/formula, along with the associated ingredients and other qualities of the blend/formula to the user, as shown by indicia 36 in FIG. 6. The blend or formula presented to the user can be restricted/modified to ensure that it always remains compliant with certain predefined parameters (e.g. complies with AAFCO regulations). The user is presented with the option 36 to either accept the proposed formulation, or go back and reformulate under either option 32 or 34.

Once the user selects a particular formulation, the formulation can then be created thereby to provide a customized “batch of one.” In one case the customized batch includes the first pet food product 18 positioned in the second container 14 and the second pet food product 20 positioned in the third container 16 as outlined above, and is fully compliant and avoids issues with settling of ingredients due to separation based on size and other properties as outlined above.

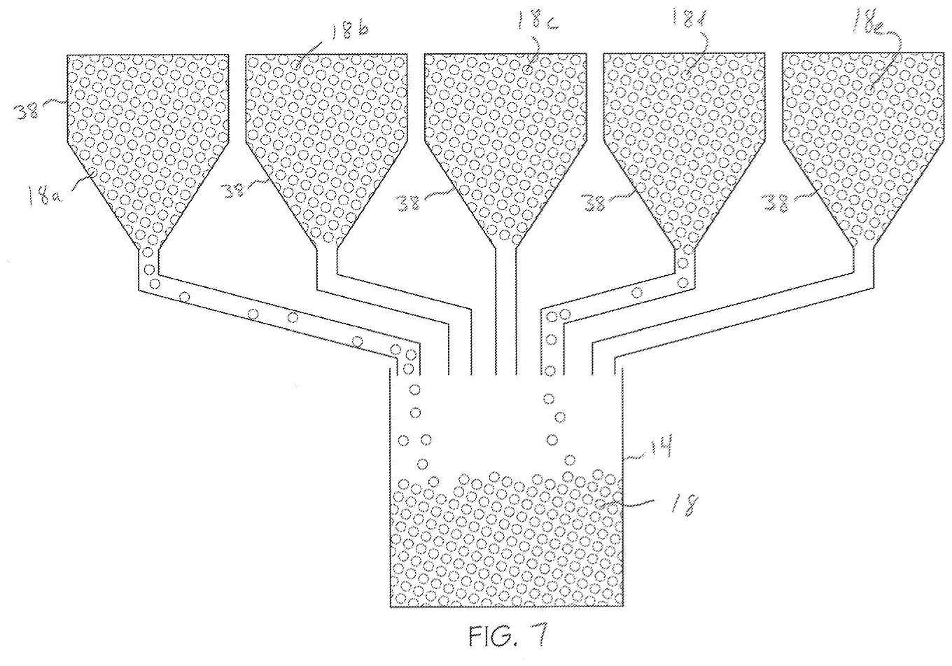

As shown in FIG. 7, various components or first pet food ingredients 18a, 18b, 18c, 18d, 18e of the first pet food product 18 can be introduced into the second container 14 by feeding ingredients 18a, 18b, 18c, 18d, 18e from various hoppers 38 which store various base ingredients 18a, 18b, 18c, 18d, 18e of the first pet food product 18. For example, each of the hoppers 38 can store pellets 18a, 18b, 18c, 18d, 18e of only a single type, or pre-blended pellets of differing types, etc., each of which can have the ingredients, size and other properties of the first pet food product 18 as outlined above. A controller can then operate the hoppers 38 such that desired amounts of the components 18a, 18b, 18c, 18d, 18e are introduced into, and fill, the second container 14 to provide the desired first pet food product 18. In the embodiment illustrated in FIG. 7, the first and fourth hoppers 38 (in a left-to-right direction) are shown as introducing their pellets 18a, 18d, respectively, into the second container 14. Of course, any of a wide variety of number of hoppers 38 can be used, and in addition, various other mechanisms and means for introducing the ingredients 18a, 18b, 18c, 18d, 18e into the second container 14 beyond the hopper arrangement shown in FIG. 7 can be utilized.

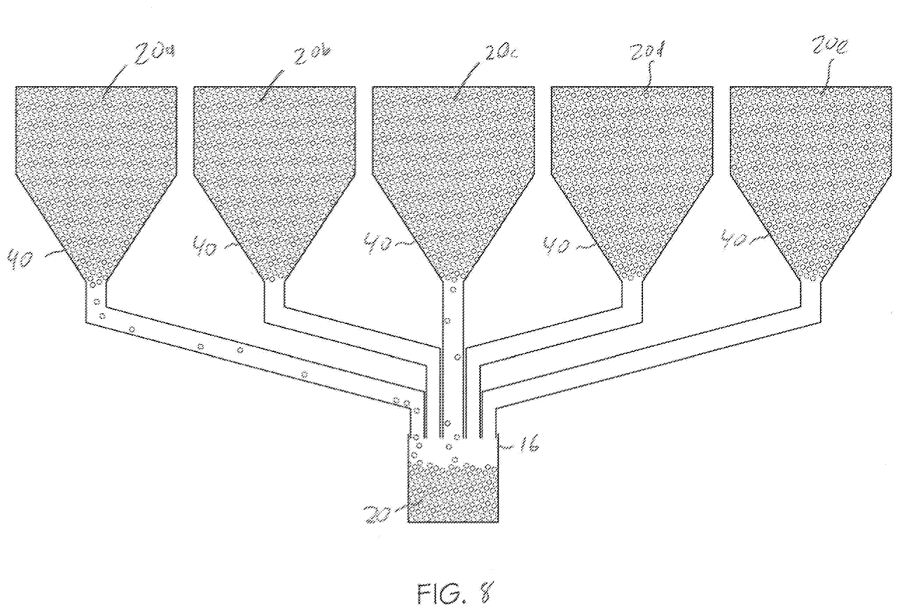

Similarly, as shown in FIG. 8 various hoppers 40 can be provided which introduce ingredients 20a, 20b, 20c, 20d and 20e of the second pet food product 20 into, and thereby form, the second pet food product 20 positioned in the third container 16. Each of the ingredients 20a, 20b, 20c, 20d and 20e in the hoppers 40 can have the ingredients, size, and other properties of the second pet food product 20 as outlined above. Again, various other means or mechanisms for introducing or forming the second pet food product 20 can be utilized, particularly given that the second pet food product 20 can take the form of a liquid, gel, powder, paste or the like.

Once the first 18 and second 20 pet food products are positioned in their respective containers 14, 16, the second 14 and third 16 containers and associated pet food products 18, 20 can, if desired, be positioned in the first container 12 as shown in FIGS. 1-3, and shipped to the user/pet owner. Upon receipt the user can open the first container 12 (if utilized) to access the second 14 and third 16 containers and/or the accompanying instructions, and open the second 14 and third 16 container to access the first 18 and second 20 pet food products. The user can then follow the instructions to provide the ingredients 18, 20 in the directed amounts and manner to provide a pet food product 21 for consumption by the pet as shown in FIG. 4.

Accordingly, the system and method disclosed herein provides the ability for creation of a completely customized batch of one pet food system, while ensuring compliance with AAFCO and/or other standards. The system also reduces settling by enabling the user to mix ingredients immediately prior to consumption. The end result is a compliant pet food product with sufficient nutrition and improved taste profile. The pet food system may also not require an additional kill step to kill any pathogens, and may not be required to be maintained in a refrigerated or frozen state.

Although the invention is shown and described with respect to certain embodiments, it should be clear that modifications will occur to those skilled in the art upon reading and understanding the specification, and the present invention includes all such modifications.

What is claimed is:

1. A pet food product comprising:
a storage container;
a first pet food product in a form of solid components having a first average particle size, wherein the first pet food product is positioned in the storage container; and
a second pet food product in a form of at least one of a liquid, a gel, a paste, a powder, or solid components having a second average particle size that is smaller than the first average particle size, wherein the second pet food product is positioned in the storage container and generally separated from the first pet food product, wherein the first pet food product alone does not provide a fully compliant pet food product, the second pet food product does not alone provide a fully compliant pet food product, and wherein the first and second pet food products have a composition such that when a sufficient amount of the first pet food product and a sufficient amount of the second pet food product are combined, a compliant pet food product results.

2. The pet food product of claim 1 wherein the first pet food product includes at least one of proteins, fruit, vegetables, carbohydrates, grains, dietary fiber or fractionated oils, and wherein the second pet food product includes at least one of oils, amino acids, minerals, enzymes, vitamins, spices, probiotics, prebiotics or nutraceuticals.

3. The pet food product of claim 1 wherein the solid components are at least one of pellets, particles or kibble.

4. The pet food product of claim 1 wherein the solid components of the second pet food product are dissolved or suspended in a solution.

5. The pet food product of claim 1 wherein an amount of the first pet food product in the storage container is at least about four times greater by volume than an amount of second pet food product in the storage container.

6. The pet food product of claim 1 wherein a minimum amount of the first pet food product and a minimum amount of the second pet food product are combinable to provide the fully compliant pet food product, and wherein the minimum amount of the first pet food product is at least about 4 times greater by volume than the minimum amount of the second pet food product.

7. The pet food product of claim 1 wherein the first pet food product is directly positioned in a second storage container, the second pet food product is directly positioned in a third storage container, and wherein the second and third storage containers are positioned in the storage container.

8. The pet food product of claim 7 wherein the second storage container substantially lacks any of the second pet food product positioned therein except what is positioned in the third storage container, and wherein the third storage container substantially lacks any of the first pet food product positioned therein.

9. The pet food product of claim 1 wherein the first pet food product is directly positioned in a second storage container, the second pet food product is directly positioned in a plurality of a third storage containers, and wherein the second and the plurality of third storage containers are positioned in the storage container.

10. The pet food product of claim 1 wherein the solid components of the first pet food product have an effective average diameter that is at least about 50% greater than effective average diameter of any solid components of the second pet food product.

11. The pet food product of claim 1 wherein the solid components of the first pet food product have an effective average diameter of between about 0.25″ and about 1″.

12. The pet food product of claim 1 wherein a compliance of the fully compliant pet food product is determined based upon standards of a national or international organization that issues guidelines or regulations for sale or distribution of animal feed.

13. The pet food product of claim 1 wherein a compliance of the fully compliant pet food product is determined based upon standards issued by the Association of American Feed Control Officials.

14. The pet food product of claim 1 wherein a composition of the first pet food product and a composition of the second pet food product are individually selected or customized for a user based upon input provided by the user.

15. A pet food product comprising:
a first pet food product which includes at least one of proteins, fruit, vegetables, carbohydrates, grains, dietary fiber or fractionated oils; and
a second pet food product which includes at least one of oils, amino acids, enzymes, minerals, vitamins, spices probiotics, prebiotics or nutraceuticals, wherein the second pet food product is generally separated from but usable in conjunction with the first pet food product, wherein the first pet food product alone does not provide a fully compliant pet food product, the second pet food product alone does not provide a fully compliant pet food product, and wherein the first and second pet food products have a composition such that when a sufficient amount of the first pet food product and a sufficient amount of the second pet food product are combined, a fully compliant pet food product results.

16. The pet food product of claim 15 further comprising a storage container, wherein the first pet food product is positioned in the storage container and the second pet food product is positioned in the storage container.

17. The pet food product of claim 16 wherein an amount of the first pet food product in the storage container is at least about four times greater by volume than an amount of second pet food product in the storage container.

18. The pet food product of claim 15 wherein the first and second pet food products are positioned in different storage containers.

19. The pet food product of claim 15 wherein the first pet food product is in the form of pellets, particles or kibble, and wherein the second pet food product is in the form of at least one of a liquid, or a gel, or a paste, or a powder, or pellets, particles or kibble.

20. The pet food product of claim 15 wherein the first pet food product has an average particle size that is greater than an average particle size of the second pet food product.

21. The pet food product of claim 15 wherein any solid components of the first pet food product have an effective average diameter that is at least about 100 percent greater than effective average diameter of any solid components of the second pet food product.

22. A method for dispensing a pet food product comprising:
accessing a first package or compartment including a first pet food product in the form of solid components having a first average particle size, wherein the first pet food product alone does not provide a fully compliant pet food product;
accessing a second package or compartment including a second pet food product in the form of at least one of a liquid, or a gel, or a paste, or a powder, or solid components having a second average particle size that is smaller than the first average particle size, wherein the second pet food product does not alone provide a fully compliant pet food product; and
mixing the first pet food product and the second pet food product together in a feeding bowl to provide a compliant pet food product.

23. The method of claim 22 wherein the first and second pet food products are positioned in a storage container.

24.-29. (canceled)
